(19) United States
(12) Patent Application Publication
(10) Pub. No.: US 2026/0367305 A1
(43) Pub. Date: Nov. 19, 2026

(54) Composite Optical Film

(71) Applicant: UBRIGHT OPTRONICS CORPORATION, Taoyuan City (TW)

(72) Inventors: Yi-Long Tyan, Taoyuan City (TW); Lung-Pin Hsin, Taoyuan City (TW); Chang-Yu Chou, Taoyuan City (TW); Chien-Chih Lai, Taoyuan City (TW); Ching-An Yang, Taoyuan City (TW); Yu-Mei Juan, Taoyuan City (TW); Te-An Chen, Taoyuan City (TW); Yu-Cheng Hsiao, Taoyuan City (TW)

(21) Appl. No.: 19/676,845

(22) Filed: May 14, 2026

Related U.S. Application Data
(60) Provisional application No. 63/806,839, filed on May 16, 2025.

(51) Int. Cl. F21V 8/00

(52) U.S. Cl. CPC G02B 6/0053

(57) ABSTRACT

This invention discloses a composite optical film, which includes a second prism optical film located on the upper side and an optical film with a reverse prism structure layer located on the lower side; wherein the optical film with the reverse prism structure layer and the second prism optical film are bonded together with a first adhesive layer.

### CROSS REFERENCE TO RELATED APPLICATION

This application claims the benefit of U.S. provisional patent application No. 63/806,839, filed on May 16, 2025, which is hereby incorporated herein by reference.

### BACKGOUND

### Field of the Invention

The present invention relates to an optical film for liquid crystal display (LCD) panels, and more particularly to a composite optical film with multifunctional low-diffusion properties and its laminated structure.

### Description of the Related Art

With continuous advances in electronic technology, there is an increasing demand for electronic display products that are lightweight, thin, compact, and energy-efficient, and that comply with environmental requirements for energy conservation and carbon reduction. Accordingly, liquid crystal display (LCD) panels have been developed toward reduced thickness, lower power consumption, and enhanced optical efficiency. In addition to reducing the thickness of panel glass substrates, overall panel brightness has been enhanced by improving the luminance performance of optical films used in backlight modules.

In a conventional backlight module, optical films play a critical role in controlling light propagation and improving luminance efficiency. Prism optical films are essential components of the backlight module. Based on principles of refraction and reflection, prism film structures are configured to redirect light toward a forward viewing direction, thereby increasing on-axis luminance. Light emitted outside a predetermined viewing angle, which would otherwise be wasted, may be recycled and reused, resulting in a significant increase in the backlight module's overall brightness. Diffusion films, on the other hand, are generally used to conceal point defects of a light guide plate and to improve luminance uniformity across the module.

Accordingly, a conventional backlight module typically comprises a plurality of optical films, including a light guide plate, a lower-diffusion film, a lower prism film, an upper prism film, and an upper diffusion film, for a total of five optical films arranged in a stacked configuration. However, such a configuration increases the backlight module's overall thickness and may adversely affect power consumption and thermal performance.

### SUMMARY

To address the aforementioned issues and meet end-users' demands for high brightness in this LCD panel product, the present invention aims to provide a composite optical film with brightness enhancement, diffusion, and light homogenization functions (i.e., isotropic light collection). This film utilizes a bead coating microstructure with diffuser and light homogenization functions, combined with a composite optical film of a reverse prism product. Alternatively, it can be a two-in-one composite optical film formed by laminating two films of the lower prism sheet together, or a three-in-one composite optical film formed by laminating three films of the lower and upper prism sheets together.

Because this two-in-one or three-in-one composite optical film simplifies the combination of two optical films into one, or three optical films into one, this film structure design not only significantly improves the overall brightness of the backlight module by 10-30%, but also effectively reduces the overall thickness of the film. Therefore, it effectively achieves: (1) reducing the thickness of the backlight unit (BLU); (2) reducing the amount of LEDs used; (3) reducing the heat source temperature generated by the LEDs in the overall backlight module; and (4) reducing the power consumption of the overall backlight module, achieving the dual benefits of thinner BLU modules and energy saving and carbon reduction.

To achieve the above objectives, one embodiment of the present invention provides a composite optical film comprising: a second prism optical film located on the upper side and an optical film with a reverse prism structure layer located on the lower side, wherein the optical film with the reverse prism structure layer and the second prism optical film are bonded together with a first adhesive resin.

In one embodiment of the present invention, the optical film having the reverse prism structure layer is formed by bonding the upper surface of the optical film with the second prism optical film using a first adhesive resin.

In one embodiment of the present invention, the optical film having the reverse prism structure layer includes a first substrate, a reverse prism structure disposed on the lower surface of the first substrate, and a frosted structure disposed on the upper surface of the first substrate. The frosted structure is formed by engraving, sandblasting, or coating with a resin containing beads.

In one embodiment of the present invention, the reverse prism structure includes multiple reverse prism s, the cross-section of which is triangular or semi-circular, and the apex of each reverse prism is configured with a height difference.

In one embodiment of the present invention, the reverse prism structure includes multiple reverse prism s, the cross-section of which is triangular, and the angle of its apex angle is 50-140 degrees.

In one embodiment of the present invention, the angle of the apex angle of the cross-section of the reverse prism is 65-125 degrees.

In one embodiment of the present invention, the second prism optical film includes a second substrate and a second prism structure disposed on the second substrate. The second prism structure includes a plurality of second prisms, wherein the plurality of second prisms are arranged with height differences or the prism lines of each second prism are wavy with left-right swinging.

In one embodiment of the present invention, the first adhesive resin is a thermosetting resin or a UV-curable resin, and its thickness is 0.5~1.5 μm.

In one embodiment of the present invention, the first adhesive resin is a transparent adhesive resin without added beads or an adhesive resin containing added beads, or the adhesive resin is an embossed matte structure.

In one embodiment of the present invention, a third prism optical film is further included on the upper side of the second prism optical film, and the third prism optical film and the second prism optical film are bonded together with a second adhesive resin.

In one embodiment of the present invention, the second adhesive resin is a thermosetting resin or a UV-curable resin, and its thickness is 0.5~1.5 μm.

In one embodiment of the present invention, the second adhesive resin is a transparent adhesive resin without added beads or an adhesive resin containing added beads, or the adhesive resin is an embossed matte structure.

In one embodiment of the present invention, the added beads are diffusion beads, which are organic compounds selected from PMMA, PS, and/or melamine, or inorganic compounds selected from silicon, SiO2, TiO2, CaCO3, Al2O3, and/or ZrO2.

In one embodiment of the present invention, the upper surface of the optical film having the reverse prism structure layer is further provided with an inverted conical structure, wherein the inverted conical structure is formed by a plurality of inverted conical structures or a plurality of inverted polygonal pyramidal structures closely arranged.

The composite optical film provided by this invention is a multifunctional composite diffusion optical film (i.e., an optical film with a reverse prism structure layer) designed by combining the isotropic light-gathering characteristics of a reverse prism with a bead-containing coating microstructure that has diffusion and light-uniformity functions. This film is bonded to a lower prism film (i.e., a second prism optical film) with adhesive resin to form a single two-in-one composite optical film. Alternatively, the light-emitting surface of the two-in-one composite optical film can be bonded to an upper prism film (i.e., a third prism optical film) with adhesive resin to form a single three-in-one composite optical film. Therefore, compared with existing technologies, it can improve brightness by 10-20%, effectively reduce the thickness and material cost of backlight units (BLUs) by approximately 1/3 to 1/2, reduce the amount of LEDs used, reduce the heat source temperature generated by the LEDs in the overall backlight module, reduce the power consumption of the overall backlight module, reduce transportation volume and cost, and simplify the BLU (Back Light Unit). The assembly process achieves multiple benefits for BLU modules, including thinning, energy saving, and carbon reduction.

The detailed technology and above preferred embodiments implemented for the present invention are described in the following paragraphs accompanying the appended drawings for people skilled in this field to well appreciate the features of the claimed invention.

### BRIEF DESCRIPTION OF DRAWINGS

The foregoing aspects and many of the accompanying advantages of this invention will become more readily appreciated as the same becomes better understood by reference to the following detailed description when taken in conjunction with the accompanying drawings, wherein:

FIG. 1 is a schematic diagram of a composite multifunctional downward diffusion optical film with diffusion effect, combining a reverse prism structure and a bead coating microstructure containing beads;

FIG. 2 is a schematic diagram of the structure of a two-in-one composite optical film in one embodiment of the present invention, in which the composite multifunctional downward diffusion optical film and the lower prism film are laminated together to form a single sheet;

FIG. 3 is a schematic diagram of the structure of a three-in-one composite optical film in one embodiment of the present invention, in which the composite multifunctional downward diffusion optical film, the lower prism film, and the upper prism film are laminated together to form a single sheet;

FIG. 4 is a two-in-one composite optical film in one embodiment of the present invention, in which the first adhesive resin contains added organic or inorganic beads.

FIG. 5A is a schematic diagram of a three-in-one composite optical film structure in one embodiment of the present invention, where the second adhesive resin contains added organic or inorganic beads;

FIG. 5B is a schematic diagram of a three-in-one composite optical film structure in one embodiment of the present invention, where both the first and second adhesive resins contain added organic or inorganic beads;

FIG. 6A is a perspective view of an optical film with an inverted prism structure layer and an inverted conical structure disposed on it, according to an embodiment of the present invention;

FIG. 6B is a cross-sectional view of an optical film with an inverted prism structure layer and an inverted conical structure disposed on it, according to an embodiment of the present invention;

FIG. 7A is a perspective view of an optical film with an inverted prism structure layer and an inverted polygonal pyramidal structure disposed on it, according to an embodiment of the present invention;

FIG. 7B is a cross-sectional view of an optical film with an inverted prism structure layer and an inverted polygonal pyramidal structure disposed on it, according to an embodiment of the present invention.

### DETAILED DESCRIPTION OF PREFERRED EMBODIMENTS

The technical solutions of the embodiments of the present invention will be described below with reference to the accompanying drawings. Obviously, the described embodiments are only a part of the embodiments of the present invention, and not all of them. All other embodiments obtained by those skilled in the art based on the embodiments of the present invention without creative effort are within the scope of protection of the present invention.

The ordinal numbers used in the specification and claims of this invention, such as "first," "second," etc., to modify the elements of the claims, do not themselves imply or represent any prior ordinal number of the claimed components, nor do they represent the order of one claimed component with another claimed component, or the order of manufacturing methods. The use of ordinal numbers is only to clearly distinguish one component with a certain name from another component with the same name.

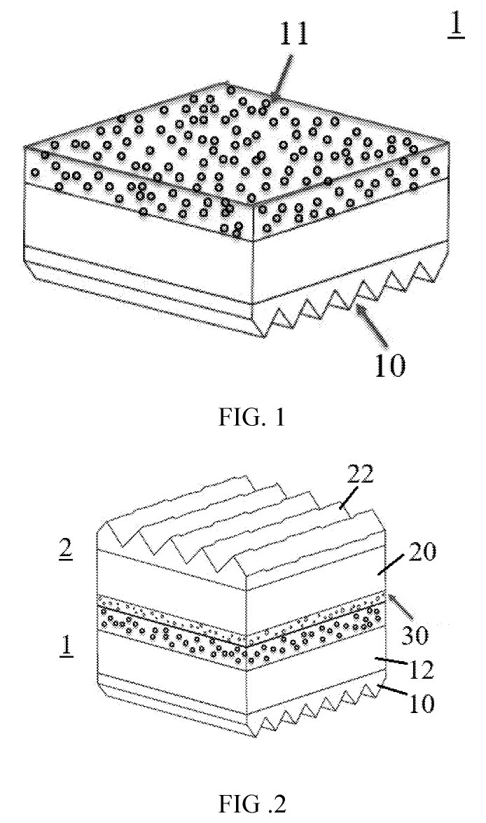

The following preferred embodiments of the present invention utilize the isotropic light-gathering principle of the reverse prism, combined with the special angle of the reverse prism structure 10, as shown in FIG. 1, the composite multifunctional downward diffusion optical film 1, which not only directly guides the light source emitted from the light guide plate vertically upward, but also further improves the utilization of the light source of the light guide plate by 10-45%. The emitting surface of the reverse prism structure 10 has an inverted pyramid structure, which serves as a diffusion layer. Furthermore, because the emitting surface incorporates a bead-coating microstructure 11, it also has a diffusion function, achieving better light uniformity and concealing effects. Therefore, in addition to its diffusion function, it effectively enhances the overall brightness gain of the composite film.

Therefore, the composite multifunctional down-diffusing optical film 1, which utilizes the down-diffusing function of the bead-coating microstructure 11 and combines it with the reverse prism structure 10, possesses the following characteristics: 1) It can replace the original down-diffusing film, thus not increasing the module thickness; 2) It does not affect the overall optical chromaticity of the module; 3) Its overall module luminance can be increased by 10-45%.

Furthermore, to achieve thinner composite optical films and simplify the assembly process, this invention employs a lamination technique to bond the light-emitting surface (i.e., the surface with the multifunctional down-diffusing bead-containing coating microstructure 11) of the aforementioned composite multifunctional down-diffusing optical film 1 to the light-incident surface (i.e., the PET surface) of the lower prism film 2. An adhesive layer 30, such as a UV adhesive, is used to bond the two optical films together into a single two-in-one composite optical film, thereby forming a composite optical film structure, as shown in FIG. 2.

Using the aforementioned bead-coating microstructure 11, which incorporates beads, for downward diffusion, combined with a reverse prism and a lower prism film 2, two films are laminated together to form a single two-in-one composite optical film. This composite film possesses the following characteristics: 1) It can replace the original downward diffusion film + lower prism film structure, thus effectively reducing the module thickness; 2) It does not affect the overall optical colorimetry of the module; 3) It can maintain the overall brightness of the module; 4) It can effectively reduce the thickness and material cost of the backlight unit (BLU) by approximately 1/3 to 1/2; 5) It reduces transportation volume and cost; 6) It simplifies the assembly process of the BLU (Back Light Unit).

Therefore, as shown in FIG. 2, one embodiment of the present invention provides a composite optical film, comprising: a second prism optical film (i.e., a lower prism film 2) located on the upper side and an optical film with a reverse prism structure layer located on the lower side (i.e., a composite multifunctional downward diffusion optical film 1), wherein the optical film with the reverse prism structure layer and the prism optical film are bonded together by a first adhesive resin (i.e., an adhesive layer 30).

In one embodiment of the present invention, the upper part of the optical film with the reverse prism structure layer is bonded to the second prism optical film by the first adhesive resin.

In one embodiment of the present invention, as shown in FIG. 2, the optical film with the reverse prism structure layer includes a first substrate 12, a reverse prism structure 10 disposed on the lower surface of the first substrate 12, and a matte structure disposed on the upper surface of the first substrate 12, wherein the matte structure can be etched, sandblasted, or coated with a resin containing beads (i.e., a bead-containing coating microstructure 11), and the first substrate 12 can be made of materials such as PET, PEN, PAr, PC, and TAC.

In one embodiment of the present invention, as shown in FIG. 2, the reverse prism structure 10 includes multiple reverse prisms, each with a triangular or semi-circular cross-section, and the apex of each reverse prism (i.e., the apex of the triangle or the top of the arc surface of the semi-circle) having a height difference.

In one embodiment of the present invention, the reverse prism structure 10 includes multiple reverse prisms, each with a triangular cross-section, and its apex angle is 50-140 degrees, preferably 65-125 degrees.

In one embodiment of the present invention, as shown in FIG. 2, the second prism optical film includes a second substrate 20 and a second prism structure 22 disposed on the second substrate 20. The second prism structure 22 includes multiple second prisms, and the second substrate 20 can be made of materials such as PET, PEN, PAr, PC, and TAC. The second prisms can be arranged with varying heights, or their edges can be designed in a wavy or other irregular shape. The height difference can be arranged in a pattern of one high and one low, or one high and two low, etc. This invention is not limited to these arrangements. The purpose of this design is to effectively improve the adhesion problem with other optical films.

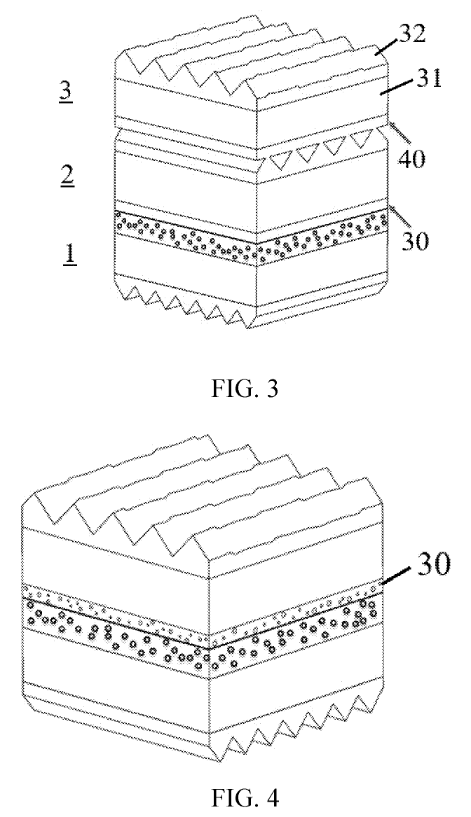

Alternatively, the light-emitting surface of the aforementioned composite multifunctional down-diffusing optical film 1 (i.e., the surface with the multifunctional down-diffusing bead-containing coating microstructure 11) is first bonded to the light-incident surface (i.e., the PET surface) of the lower prism film 2. Using an adhesive layer 30, such as UV adhesive, the two optical films are bonded together into a single two-in-one composite optical film. Then, this is bonded to the light-incident surface (i.e., the PET surface) of the upper prism film 3. Using an adhesive layer 40, such as UV adhesive, the three optical films are bonded together into a single three-in-one composite optical film, thus forming another composite optical film structure, as shown in FIG. 3.

Therefore, as shown in FIG. 3, one embodiment of the present invention provides another composite optical film, which, in addition to an optical film with a reverse prism structure layer located on the lower side (i.e., composite multifunctional downward diffusion optical film 1) and a second prism optical film located on the upper side (i.e., lower prism film 2), also includes a third prism optical film located above the second prism optical film (i.e., upper prism film 3), wherein the third prism optical film and the second prism optical film are bonded together with a second adhesive resin (i.e., adhesive layer 40).

In one embodiment of the present invention, the upper part of the second prism optical film is bonded to the third prism optical film with the second adhesive resin to form the third prism optical film.

In one embodiment of the present invention, the third prism optical film has a similar structure to the second prism optical film, as shown in FIG. 3, and includes a third substrate 31 and a third prism structure 32 disposed on the third substrate 31. The third prism structure 32 includes multiple third prisms, and the third substrate 31 can be made of materials such as PET, PEN, PAr, PC, and TAC. The third prisms can be arranged with varying heights, or their edges can be designed in a wavy or other irregular shape, and this invention is not limited to these limitations.

In one embodiment of this invention, as shown in FIG. 2, the first adhesive resin (adhesive layer 30) of the two-in-one composite optical film can be a thermosetting or UV-curable resin, with a layer thickness controlled between 0.5 and 1.5 μm. The adhesion method can be physical or chemical, and the adhesion strength can reach 50 g/25 mm or higher.

In one embodiment of this invention, as shown in FIG. 3, the first and second adhesive resins (adhesive layers 30 and 40) can both be thermosetting or UV-curable resins, with a layer thickness controlled between 0.5 and 1.5 μm. The adhesion method can be physical or chemical, and the adhesion strength can reach 50 g/25 mm or higher.

In one embodiment of the two-in-one composite optical film, the first adhesive resin can be a transparent adhesive resin without added beads (beads) for bonding. In another embodiment, the first adhesive resin can also be an adhesive resin containing added beads (beads) for bonding, as shown in adhesive layer 30 in FIG. 4, or it can be a matte structure formed by embossing.

The added beads are diffusing beads, which can be organic materials selected from PMMA, PS, melamine, etc., or inorganic materials selected from silicon, SiO2, TiO2, CaCO3, Al2O3, ZrO2, etc., with a haze range of 2% to 60%, preferably 10% to 30%.

When the first adhesive resin is a matte structure formed by embossing, it is specifically coated using an embossed matte structure, with a haze range of 2% to 90%, preferably 10% to 40%.

In one embodiment of the three-in-one composite optical film, both the first and second adhesive resins are transparent adhesive resins without added beads for bonding, as shown in adhesive layers 30 and 40 in FIG. 3.

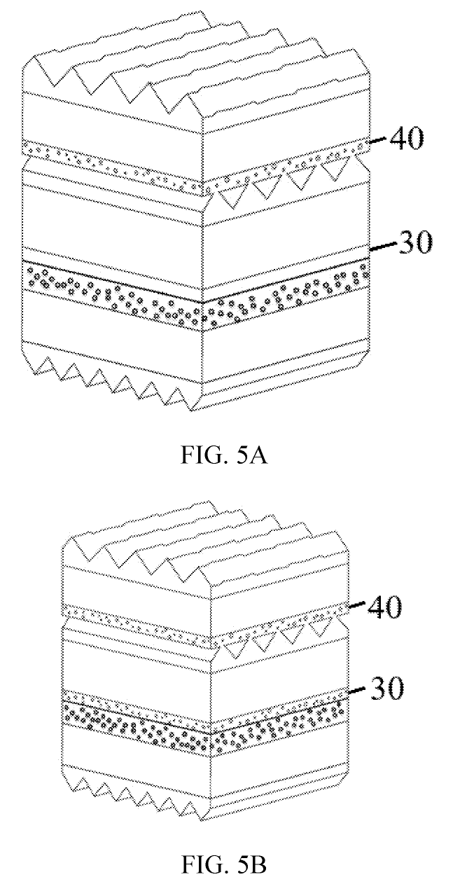

In another embodiment of the three-in-one composite optical film, the first adhesive resin is a transparent adhesive resin without added beads for bonding, as shown in adhesive layer 30 in FIG. 5A, while the second adhesive resin is an adhesive resin containing added beads for bonding, as shown in adhesive layer 40 in FIG. 5A, or it may be a matte structure formed by embossing.

In yet another embodiment of the three-in-one composite optical film, both the first and second adhesive resins are adhesive resins containing added beads for bonding, as shown in adhesive layers 30 and 40 in FIG. 5B, or it may be a matte structure formed by embossing.

The added beads are diffusion beads, which can be organic materials selected from PMMA, PS, melamine, etc., or inorganic materials selected from silicon, SiO2, TiO2, CaCO3, Al2O3, ZrO2, etc., with a haze range of 2% to 60%, preferably 10% to 30%.When the first and/or second adhesive resins are embossed matte structures, specifically, an embossed matte structure is used for coating, with a haze range of 2% to 90%, preferably 10% to 40%.

In one embodiment of the invention, the upper surface of the optical film with the reverse prism structure layer is further provided with an inverted conical structure, wherein the inverted conical structure can be formed by a close arrangement of multiple inverted conical structures or multiple inverted polygonal pyramidal structures.

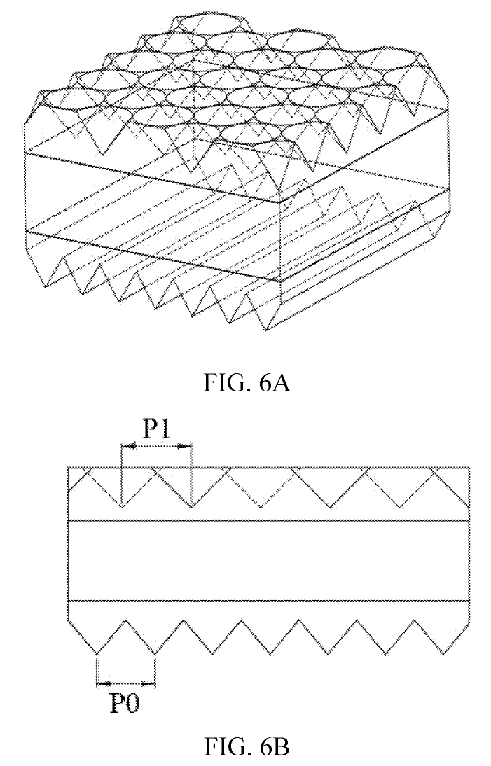

As shown in FIGS. 6A and 6B, the inverted conical structure is composed of multiple closely arranged inverted conical structures. The cone pitch P1 of any two inverted conical structures can be the same as or different from the prism spacing P0 of any two inverse prisms.

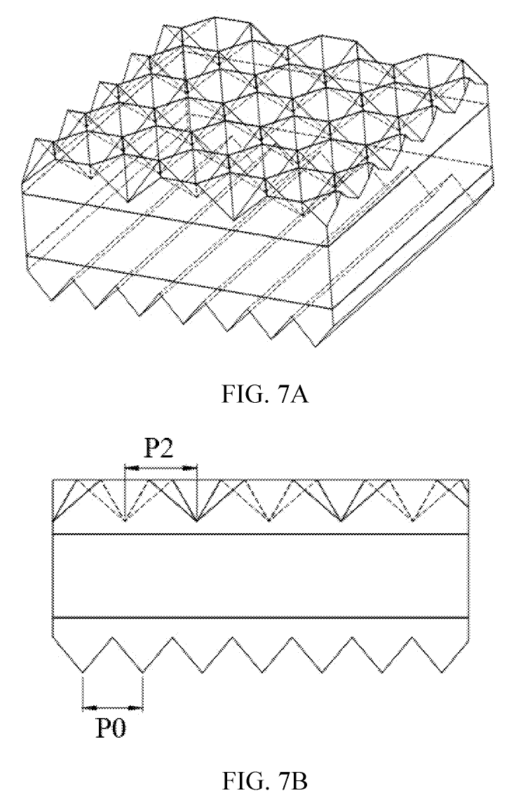

As shown in FIGS. 7A and 7B, the inverted conical structure is composed of multiple closely arranged inverted polygonal pyramidal structures, such as the hexagonal pyramid shown in the figure, but not limited to this. The polygonal pyramid pitch P2 of any two inverted polygonal pyramidal structures can be the same as or different from the prism spacing P0 of any two inverse prisms.

In summary, the composite optical film provided by this invention is a multifunctional composite diffusion optical film (i.e., an optical film with a reverse prism structure layer) designed by combining the isotropic light-gathering characteristics of a reverse prism with a bead-containing coating microstructure that has diffusion and light-leveling functions, and is laminated with a lower prism film and/or an upper prism film to form a single two-in-one or three-in-one composite optical film. Therefore, it has at least the following advantages:1) under the same backlight module, using the multifunctional composite diffusion optical film designed by combining the isotropic light-gathering characteristics of a reverse prism with a bead-containing coating microstructure that has diffusion and light-leveling functions, the overall brightness of the module can be increased by 10-20%; 2) by using the lower prism film and/or the upper prism film and the composite diffusion optical film with diffusion and light-leveling functions to form a single two-in-one or three-in-one optical film, the adhesive resin uses no added beads (Beads), which can achieve the required high brightness and effectively reduce the thickness of the backlight unit (BLU); 3) reduces LED usage and improves overall backlight module power consumption, achieving thinner design and energy-saving/carbon-reducing benefits; 4) uses a lower prism film and/or an upper prism film bonded to a composite diffusion optical film with diffusion and light-diffusing functions, forming a single two-in-one or three-in-one optical film. The adhesive resin uses added organic or inorganic beads (Beads) to replace the upper diffuser, achieving thinner design and high brightness, effectively reducing the overall backlight unit (BLU) thickness by approximately 1/3 to ½; 5) by bonding them into a single two-in-one or three-in-one optical film, the thermal stability and anti-wrinkle properties of the optical film are effectively improved; 6) does not affect the overall module's optical colorimetry; 7) reduces transportation volume and cost, and simplifies the BLU (Back Light Unit) assembly process.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they are substantially covered in the appended claims.

What is claimed is:

1. A composite optical film, comprising a second prism optical film located on an upper side and an optical film having a reverse prism structure layer located on a lower side; wherein the optical film having the reverse prism structure layer and the second prism optical film are bonded together with a first adhesive layer.

2. The composite optical film according to claim 1, wherein the upper part of the optical film having the reverse prism structure layer is adhered to the second prism optical film through the first adhesive resin.

3. The composite optical film according to claim 1, wherein the optical film having the reverse prism structure layer comprises a first substrate, a reverse prism structure disposed on the lower surface of the first substrate, and a matte structure disposed on the upper surface of the first substrate.

4. The composite optical film according to claim 3, wherein the matte structure is formed by coating with a resin containing beads.

5. The composite optical film according to claim 3, wherein the matte structure is formed by engraving.

6. The composite optical film according to claim 3, wherein the matte structure is formed by sandblasting.

7. The composite optical film according to claim 3, wherein the reverse prism structure comprises a plurality of reverse prisms, the cross-section of the plurality of reverse prisms being triangular or semi-circular, and the apex of each reverse prism being configured with a height difference.

8. The composite optical film according to claim 7, wherein the reverse prism structure comprises a plurality of reverse prisms, the cross-section of the reverse prisms being triangular, and the angle of their apex angle being 50-140 degrees.

9. The composite optical film according to claim 7, wherein the angle of the apex angle of the cross-section of the reverse prism is 65-125 degrees.

10. The composite optical film according to claim 1, wherein the first adhesive layer further comprises added beads to provide a diffusion effect.

11. The composite optical film according to claim 1, wherein the first adhesive layer comprises a matte structure formed by embossing.

12. The composite optical film according to claim 1, further comprising a third prism optical film located above the second prism optical film, the third prism optical film being bonded to the second prism optical film with a second adhesive layer.

13. The composite optical film according to claim 12, wherein the second adhesive layer further comprises added beads to provide a diffusion effect.

14. The composite optical film according to claim 12, wherein the second adhesive layer comprises a matte structure formed by embossing.

15. The composite optical film according to claim 1, wherein the upper surface of the optical film having the reverse prism structure layer is further provided with an inverted conical structure, wherein the inverted conical structure is formed by a plurality of inverted conical structures or a plurality of inverted polygonal pyramidal structures closely arranged.
